(19) United States
(12) Patent Application Publication
(10) Pub. No.: US 2011/0173313 A1
(43) Pub. Date: Jul. 14, 2011

(54) Portable Management Device

(76) Inventors: Eric Owhadi, Tomball, TX (US); Theodore F. Emerson, Tomball, TX (US); Jeffery L. Galloway, The Woodlands, TX (US)

(21) Appl. No.: 13/120,831

(22) PCT Filed: Oct. 7, 2008
(86) PCT No.: PCT/US08/79086

§ 371 Date: Mar. 24, 2011

(51) Int. Cl. G06F 15/16

(52) U.S. Cl. 709/223

(57) ABSTRACT

Exemplary embodiments of the present invention disclosed herein relate to a method and system for providing remote management for a computer system with a portable management device. An exemplary method comprises connecting a portable management device to a computer system and a network. The exemplary method additionally comprises receiving remote management data over the network via the portable management device and executing instructions in response to the remote management data.

### BACKGROUND

Helpdesk support efficiency may be measured in terms of cost, customer satisfaction, down time or the like. Remote support technologies, sometimes known as eSupport technologies, may allow a service department to solve problems efficiently, without requiring desk-side visits or call backs. Remote support technologies that employ a dedicated management channel are sometimes referred to as out-of-band management technologies.

Remote desktop sharing is one example of a remote management technology that reduces guesswork and frustration that may result from a telephone conversation in which a technician cannot view events happening on a user's computer. Nonetheless, remote desktop sharing has at least one important disadvantage. That disadvantage is that the user's computer must have a functioning operating system (OS) before remote desktop sharing can take place. If the user's computer will not boot, for example, remote desktop sharing is not an option for service.

The inability to effectively perform remote repair operations on systems with no functioning OS is a costly problem. This problem is particularly costly for enterprises with many scattered offices, such as insurance companies or the like. For such enterprises, desk-side visits are significantly more expensive than remote repair.

### BRIEF DESCRIPTION OF THE DRAWINGS

Certain exemplary embodiments are described in the following detailed description and in reference to the drawings, in which:

FIG. 1 is a block diagram of a system of computers in accordance with an exemplary embodiment of the present invention;

FIG. 2 is a block diagram of a dongle that is adapted to provide remote management capability in accordance with an exemplary embodiment of the present invention; and

FIG. 3 is a process flow diagram showing a method of providing remote management capability to a computer system in accordance with an exemplary embodiment of the present invention.

### DETAILED DESCRIPTION OF SPECIFIC EMBODIMENTS

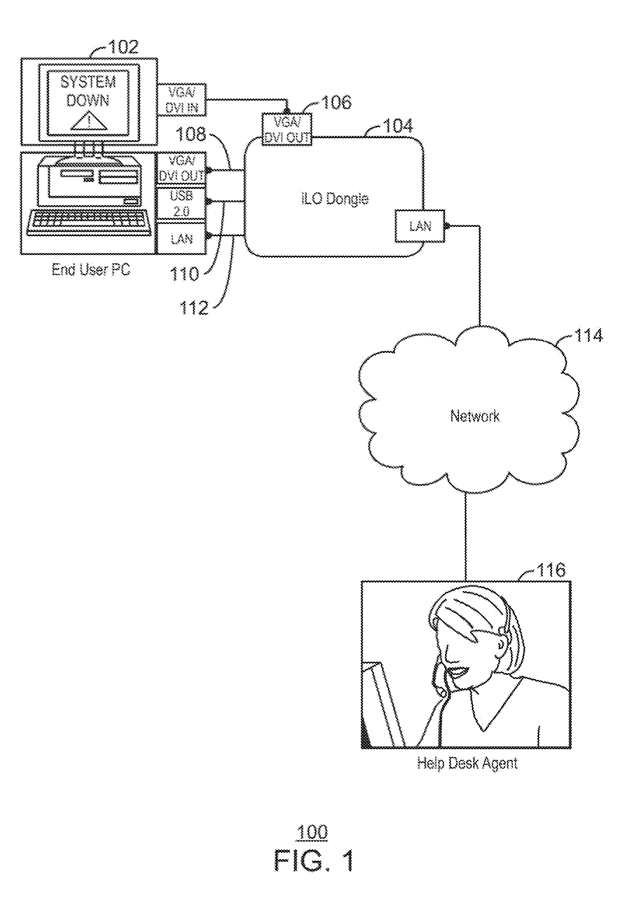

FIG. 1 is a block diagram of a system of computers in accordance with an exemplary embodiment of the present invention. The system is generally referred to by the reference number 100. The system 100 comprises a computer system 102. In one exemplary embodiment of the present invention, a dongle 104 is connected to the computer system 102. As used herein, the term “dongle” refers to a device that may be connected to a computer system. The dongle 104 functions as a portable management device that provides remote management capability for the computer system 102. The dongle 104 enables a remote support person to take control of the computer system 102 and remotely view its desktop, just as a user would view the desktop of the computer system 102 if logged on to it locally. As will be explained in detail below, the dongle 104 is able to provide remote management capability by sharing a network connection with the computer system 102. In one exemplary embodiment of the present invention, no local control devices such as a keyboard or mouse of the computer system 102 are required to be connected to the dongle 104.

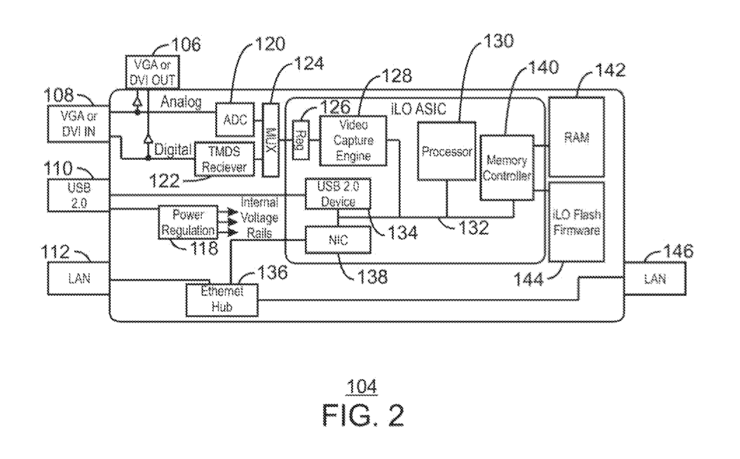

A video connection and a universal serial bus (USB) connection allow the dongle 104 to provide true out-of-band management capability. The dongle 104 includes a video input 108 to receive video data from the computer system 102. A video output 106 provides a way to also connect a local monitor of the computer system 102. The video input 108 allows the output of the video controller on computer system 102 to render images both on a local monitor (via the video output 106) and a remote computer system located at a remote support center 116 via video redirection logic shown and described in detail below with reference to FIG. 2. In one exemplary embodiment of the present invention, the dongle comprises a light emitting diode (LED) that indicates whether video information is sensed. This allows a user at the location of the computer system 102 to press a specific combination of keys (for example, function-F4) if such a specific input is needed to deliver video data to an external connection so that it may be viewed by a service person at a remote location. By way of example, the input of a specific combination of keys may be needed to deliver video data to an external connection of a notebook computer.

A USB connection 110 allows the dongle 104 to present USB-based peripherals to computer system 102. These peripherals may include a keyboard and/or pointing device (used for remote control) and/or a storage device (used for remote boot or remote media). In one exemplary embodiment of the present invention, the dongle 104 provides multiple virtual media support and a high performance graphical remote desktop. The virtual media support may provide 40× CD speed to facilitate efficient remote loading of an ISO from an ISO image.

A network connection 112 allows the dongle 104 to share a network connection with the computer system 102. The dongle 104 may be remotely accessible via a network 114 by the support center 116. Those of ordinary skill in the art will appreciate that the network 114 may comprise any appropriate type of network. Examples of such networks include the Internet, a local area network (LAN), a wireless local area network (WLAN), a wireless wide area network (WWAN) or the like.

The dongle 104 may be available for use by a plurality of computer systems at a location that is remote relative to a support center. The dongle may include management features including a mechanical remote lock to help insure that dongles are always kept in a specific location. Moreover, a mechanical remote lock may only be releasable by a support specialist so that the dongle may be returned to the specific location. In one exemplary embodiment of the present invention, the dongle 104 may be transported to the location of the computer system 102 when needed to perform a remote management operation if, for example, the computer system 102 is unable to perform a boot operation.

In one exemplary embodiment of the present invention, the dongle 104 is adapted to facilitate remote repairs that would typically require a more expensive desk-side service visit. Moreover, the dongle 104 is desirably adapted to provide multi-vendor support. In one exemplary embodiment of the present invention, the dongle 104 may be embedded in a remote management docking station, which may be adapted to receive notebook computer systems for remote repair operations. Those of ordinary skill in the art will appreciate that the dongle 104 provides a portable, low cost manageability subsystem that may be employed in systems for which it is not cost effective to embed a dedicated manageability subsystem.

FIG. 2 is a block diagram of the dongle 104 introduced in FIG. 1. As set forth above, the dongle 104 is adapted to provide remote management capability in accordance with an exemplary embodiment of the present invention. The dongle 104 comprises a power regulation circuit 118, which is adapted to provide power to the other functional blocks shown in FIG. 2. The dongle 104 may be adapted to receive power from a wide range of sources, including a battery, one or more USB connectors or an external power cord, to name just a few examples.

An analog-to-digital converter (ADC) 120 is connected to the video output 106 and the video input 108 to allow the dongle 104 to receive analog video data. Similarly, a transition minimized differential signaling (TMDS) circuit 122 is connected to the video output 106 and the video input 108 to allow the dongle 104 to receive digital video data. The outputs of the ADC 120 and the TMDS circuit 122 are delivered to a multiplexer 124. The output of the multiplexer 124 is stored in a register 126 so that it may be accessed by a video capture engine 128. The video capture engine 128 allows a remote user to view events on the computer system to which the dongle 104 is connected.

The dongle 104 includes a processor, which is adapted to control the overall operation of the dongle 104. Moreover, the processor 130 is adapted to receive management data over the network 114. The processor 130 is connected to various other functional blocks of the dongle 104 via an internal bus 132. The protocol employed by the internal bus 132 may vary depending on system design considerations.

A USB device 134 is connected to the USB connection 110. The USB device 134 is connected to the processor 130 via the internal bus 132 so that the dongle 104 may process USB data received from the computer system 102. In one exemplary embodiment of the present invention, the processor 130 may employ the USB device 134 to present a variety of USB peripherals to the computer system 102. Examples of devices that may be presented by the processor 130 via the USB device 134 include a virtual USB keyboard and/or mouse, an optical drive, a floppy drive or the like. The processor 130 provides a full transmission control protocol/Internet protocol (TCP/IP) stack, as well as support for dynamic host configuration protocol (DHCP), secure sockets layer (SSL) and/or transport layer security (TLS). The USB device 134 may be employed as a virtual USB hub in accordance with an exemplary embodiment of the present invention. A hardware accelerated remote control protocol similar to virtual network computing (VNC) may also be provided.

An Ethernet hub 136 is connected to the network connection 112 to allow the dongle to receive network communications from the computer system 102. These network communications may include management data from the support center 116. The Ethernet hub 136 is connected to a network interface card (NIC) 138. The USB device 134 and the NIC 138 are connected to the processor 130 via the internal bus 132 so that the processor may process data received from the computer system 102 or the network 114. In one exemplary embodiment of the present invention, the dongle 104 may be adapted to implement an embedded web server and/or enterprise-class authentication options. These functions may be implemented in firmware running on the processor 130 using the NIC 138 for communication.

The exemplary dongle 104 shown in FIG. 2 includes a memory controller 140, which is connected to other system components via the internal bus 132. The memory controller 140 is adapted to manage data flow between the processor 130 and memory resources of the dongle 104. In the exemplary embodiment shown in FIG. 2, the memory controller 140 manages a random access memory (RAM) 142 and a non-volatile memory 144. The non-volatile memory 144 may be used to store machine-readable programming such as firmware. The firmware may be read by the processor 130 and used to control the operation of the dongle 104.

A second network input 146 may be connected to the Ethernet hub 136. The second network input 146 may allow the dongle 104 to be connected to the support center 116 via the network 114. Moreover, the Ethernet hub 136 allows the support center 116 to communicate with two different network entities: the dongle 104 and the computer system 102.

In operation, a person who is in the same location as the computer system 102 connects the dongle 104 between the computer system 102 and the network 114. A service person at the remote support center 116 may then access the dongle 104 using an interface such as a web browser or the like. In one exemplary embodiment of the present invention, the service person accesses an embedded web server disposed in the dongle 104.

The service person may log on to the dongle 104 and access a remote desktop sharing viewer. One exemplary remote desktop sharing viewer comprises an ActiveX control served from the embedded web server of the dongle 104. The remote desktop sharing viewer may allow the service person to see the desktop of the computer system 102 and to control the operation of the computer system 102 remotely via the service person's keyboard and mouse. The service person may remotely mount a drive such as an optical drive to the dongle to allow the remote loading of an OS to the computer system 102. For example, the service person may install a Windows DVD into a drive located at the service center 116 and mount the drive remotely to the dongle 104. The service person may remotely change the basic input/output system (BIOS) settings of the computer system 102 so that the system boots from the virtual drive mounted to the dongle 104. The computer system 102 may then receive information that causes it to reboot to trigger installation of a new operating system. In this manner, the dongle 104 may provide remote support to computer systems that do not have functioning OSes.

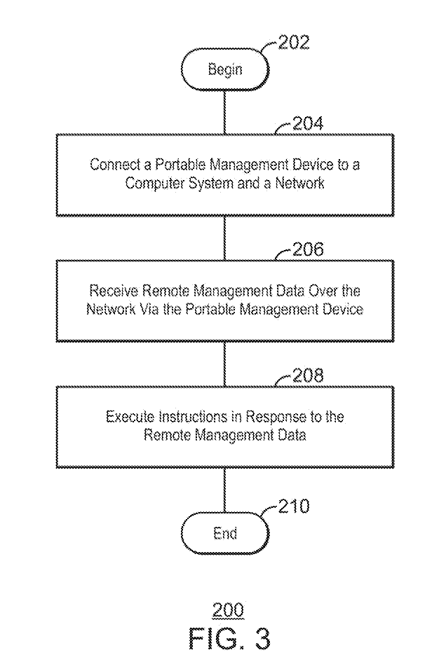

FIG. 3 is a process flow diagram showing a method of providing remote management capability to a computer system in accordance with an exemplary embodiment of the present invention. The method is generally referred to by the reference number 200. At block 202, the method begins.

At block 204, a portable management device is connected to the computer system and to a network. Remote management data is received over the network via the portable management device, as shown at block 206. In an exemplary embodiment of the present invention, the remote management data is received from a remote service center. At block 208, the computer system executes instructions in response to the remote management data. At block 210, the method ends.

A dongle in accordance with an exemplary embodiment of the present invention provides the ability for enterprises that manage a large number of computer systems to standardize on a single management model, even though the enterprise may have computer systems from several manufacturers. Moreover, such a dongle provides a portable, cost-effective to add remote management capability to a computer system that does not otherwise have such capability. For example, a dongle according to an exemplary embodiment of the present invention allows businesses that service computer systems to use remote management capability to repair systems consumer-class systems, which do not typical include remote management capability. For some repairs, a dongle according to an exemplary embodiment of the present invention could be sent to the end user who could connect it to a disabled computer system. The system could then be remotely repaired with no on-site visit by a service person.

What is claimed is:

1. A method of providing remote management capability to a computer system, the method comprising:
connecting a portable management device to a computer system and a network;
receiving remote management data over the network via the portable management device; and
executing instructions in response to the remote management data.

2. The method recited in claim 1, comprising transmitting video data representative of activity taking place on the computer system to a remote service center via the portable management device.

3. The method recited in claim 1, wherein the management data comprises information that causes the computer system to reboot.

4. The method recited in claim 1, wherein the management data comprises a command to mount a remote drive.

5. The method recited in claim 1, wherein the portable management device comprises a dongle.

6. The method recited in claim 1, wherein connecting the portable management device does not comprise connecting local control devices of the computer system to the portable management device.

7. The method recited in claim 1, comprising providing emulation of at least one of a keyboard or a mouse.

8. The method recited in claim 1, wherein the portable management device comprises a docking station.

9. A portable management device, comprising:
a first network connector that is adapted to allow a network connection between the portable management device and a computer system;
a second network connector that is adapted to allow a network connection between the portable management device and a network; and
a processor that is adapted to receive remote management data from the network via the portable management device and to execute instructions in response to the remote management data.

10. The portable management device recited in claim 9, wherein the processor is adapted to transmit video data representative of activity taking place on the computer system to a remote service center via the network.

11. The portable management device recited in claim 9, wherein the management data comprises information that causes the computer system to reboot.

12. The portable management device recited in claim 9, wherein the management data comprises a command to mount a remote drive.

13. The portable management device recited in claim 9, wherein the portable management device comprises a dongle.

14. The portable management device recited in claim 9, wherein the portable management device is adapted to provide emulation of at least one of a keyboard or a mouse.

15. The portable management device recited in claim 9, wherein the portable management device comprises a docking station.
